(19) United States
(12) Patent Application Publication
(10) Pub. No.: US 2004/0193504 A1
(43) Pub. Date: Sep. 30, 2004

(54) System and method for intermediation between users and abata providers to provide various abata images to users

(76) Inventors: Jong-Min Hahm, Seoul (KR); Jung-Rae Cho, Seoul (KR)

Correspondence Address: JONES DAY, 222 EAST 41ST ST, NEW YORK, NY, 10017, US

(21) Appl. No.: 10/766,704

(22) Filed: Jan. 27, 2004

(30) Foreign Application Priority Data
Apr. 3, 2002 (KR) 10-2002-0018354

(51) Int. Cl. G06F 17/60; G06F 17/30

(52) U.S. Cl. 705/26; 707/3

(57) ABSTRACT

System and method for allowing users to freely select and use various abata images provided by a plurality of abata image providers are disclosed.

The abata intermediating system includes an abata providing device for storing abata data having abata image and abata item image and providing the abata data through a network; an abata service device for receiving the abata data from the abata providing device and supplying the abata data in a shape of web document or the like; a user terminal for outputting the abata data through the abata service device or a client program like a messenger; and an abata intermediating device for introducing the abata data provided from at least one abata providing device, intermediating transaction of the abata data between a selected one of the abata providing devices and the user terminal, receiving a changed abata image from the corresponding abata providing device in response to an abata change request, and then changing a representative abata image of the abata service device or the client program into the changed abata image.

### BACKGROUND OF THE INVENTION

1. Field of the Invention

The present invention relates to a method for receiving and displaying images through an electronic network, and more particularly to system and method for allowing users to freely select and use various abata images provided by a plurality of abata image providers.

2. Description of the Related Art

An abata is another virtual self, expressing the user himself/herself in a cyber space. This abata is generally provided to a user through Internet service systems such as a community site, a portal site or an Internet shopping mall, or sometimes provided directly from an abata provider.

In the conventional abata service, one service system or one abata providing system provides only one type of abata image, so abata images in the system are very monotonous. Thus, young generations who seek variety are apt to be easily tired of their abata, so the monotonous abata image impedes spread of the abata.

In addition, when an existing abata service or an existing abata provider is changed, the Internet service provider should change its service system since the abata is not compatible.

Thus, there is a need to develop a technique that allows users to use various types of abata provided by a plurality of abata providers without changing the system.

### SUMMARY OF THE INVENTION

The present invention is designed to solve the problems of the prior art, and therefore it is an object of the present invention to provide a method for allowing users to use various types of abata without system change by using an intermediating system between a plurality of abata providers and an Internet service provider.

In addition, another object of the invention is to provide an abata intermediating system and method that is capable of interfacing between a plurality of abata providers and a program using abata like an instant messenger of a user terminal.

According to one aspect of the invention, the present invention provides an abata intermediating system, which includes an abata providing device for storing abata data having abata images and abata item images and providing the abata data through a network; an abata service device for receiving the abata data from the abata providing device and supplying the abata data in a shape of web document or the like; a user terminal for outputting the abata data through the abata service device or a client program like a messenger; and an abata intermediating device for introducing the abata data provided from at least one abata providing device, intermediating transaction of the abata data between a selected one of the abata providing devices and the user terminal, receiving a changed abata image from the corresponding abata providing device in response to an abata change request, and then changing a representative abata image of the abata service device or the client program into the changed abata image.

Preferably, the abata providing device includes a storage area for storing the purchased abata data for each user; an abata composing unit for generating a perfect abata image by combining the abata image stored in the storage area with various abata item images; a unit for providing the perfect abata image to the abata intermediating device in response to the change request of the user; and a unit for providing transaction information of the corresponding abata data to the abata intermediating device in response to a purchase request of a specific abata data from the user.

Preferably, the abata intermediating device includes an abata purchasing unit for providing an abata data list from at least one abata providing device to users, transmitting a purchase request of a specific abata data from a user to the corresponding abata providing device when the user requests for purchasing the abata data, outputting the abata purchasing information received from the abata providing device to the user, receiving payment information from the user, and then transmitting payment settlement to the abata providing device, and an abata storage area for storing a composed abata image transmitted from the abata providing device for each user.

In this case, the abata intermediating system may further include an abata changing unit for receiving and storing an abata image change request and a changed abata data from a specific abata providing device, and informing the abata service device or the client program of the user terminal that the abata image is changed.

Preferably. the abata changing unit includes a unit for receiving change request information from a specific abata providing device, inputting a change request item into a wait queue, and storing temporary abata information into a database; a unit for reading the stored change request item from the wait queue and requesting transmission of the abata data to the corresponding abata providing device; a unit for receiving and storing the abata data transmitted from the abata providing device and restoring the temporary abata information stored in the database; and a unit for informing the abata service device or the client program of the user terminal that the abata image is changed.

Preferably, the change request item includes user identification information and abata provider identification information.

In addition, the temporary abata information preferably includes user identification information and a temporary abata URL.

The abata intermediating device may further include an abata display unit for providing the abata image stored in the abata storage area to the client program or the abata service device in response to an abata display request from the client program of the user terminal or the abata service device.

Preferably, the abata display unit performs receiving abata display information including user identification information, kind of abata, abata countenance or the like from the client program of the user terminal or the abata service device; determining on the basis of the abata display information whether the abata to be provided is a formal abata or a temporary abata; and requesting provision of the abata image to the abata providing device in case of temporary abata, and providing an abata image stored in the abata storage area in case of formal abata.

According to another aspect of the invention, there is also provided an abata intermediating method for executing an abata intermediating system which interfaces between a plurality of abata providing systems and an abata-using Internet service system or an abata-using program of a user terminal via a network in order to reflect an abata image, set by selection of a user among various types of abata images provided from a plurality of abata providing systems, on the abata-using Internet service system or the abata-using program of the user terminal, wherein the method includes the steps of building a user information database for storing and managing user identification information and abata display information corresponding to the user identification information, and an abata provider information database for storing and managing environment and data of a plurality of abata providing systems; setting a representative abata image to be displayed in the abata-using Internet service system or the abata-using program of the user terminal, and storing the representative abata image into an abata storage area; accessing the abata intermediating system via the network and inputting user identification information; outputting a list of abata providing systems connected to the abata intermediating system and an abata data list of each abata providing system to the user; purchasing a specific abata image or abata item in the abata data list, and storing the purchased abata data into the corresponding abata providing system together with the user identification information; composing an abata image with the use of the abata image and abata item stored in a specific abata providing system, and requesting the corresponding abata providing system to change the representative abata image into the composed abata image; transmitting the abata image change request to the abata intermediating system; informing the abata-using Internet service system or the abata-using program of the user terminal on the basis of the abata image change request that the abata image is changed; and receiving the abata image from the corresponding abata providing system according to the abata image change request, and updating the representative abata image of the abata storage area on the basis of the received abata image.

Preferably, the abata image updating step includes receiving the abata image change request, inputting a change request item (the user identification information and the abata provider identification information) into a wait queue, and storing temporary abata information (the user identification information and URL of the temporary abata) into a database; reading the stored change request item from the wait queue and requesting transmission of the abata data to the corresponding abata providing device; and receiving the abata image transmitted from the corresponding abata providing system to update the representative abata image of the abata storage area, and restoring the temporary abata information of the user information database.

In this case, the abata intermediating method may further include the steps of, in the abata-using program informed of the abata change from the abata intermediating system, transmitting the abata display information including user identification information, kind of abata, abata countenance or the like to the abata intermediating system in order to display the changed abata image; and in the abata intermediating system, determining whether the transmitted abata display information is coincident with the abata display information stored in the user information database; determined whether an abata included in the corresponding abata display information is a temporary abata or a formal abata in case the information is coincident; and updating and displaying the representative abata image on the basis of the URL of the temporary abata stored in the user information database in case of temporary abata, on the while, transmitting the abata image stored in the abata storage area to the user terminal, and updating and displaying the representative abata image in case of formal abata.

### BRIEF DESCRIPTION OF THE DRAWINGS

Other objects and aspects of the present invention will become apparent from the following description of embodiments with reference to the accompanying drawing in which:

FIG. 1 shows configuration of a network system in which an abata intermediating method according to the present invention is realized;

FIG. 2 shows detailed configuration of an abata providing system and an abata intermediating system of FIG. 1;

FIG. 3 is a flow chart for illustrating the process of purchasing an abata image or abata item from a specific abata providing system through the abata intermediating system according to the present invention;

FIG. 4 is a flowchart for illustrating the process of changing a representative abata set in the messenger of a user terminal through the abata intermediating system;

FIG. 5 shows functional processes for executing the process of FIG. 4; and

FIG. 6 is a flowchart for illustrating the process of displaying an abata on the service system or the user terminal through the abata intermediating system according to the present invention.

### DESCRIPTION OF THE PREFERRED EMBODIMENT

Hereinafter, abata intermediating system and method according to the present invention will be described in more detail with reference to the drawings.

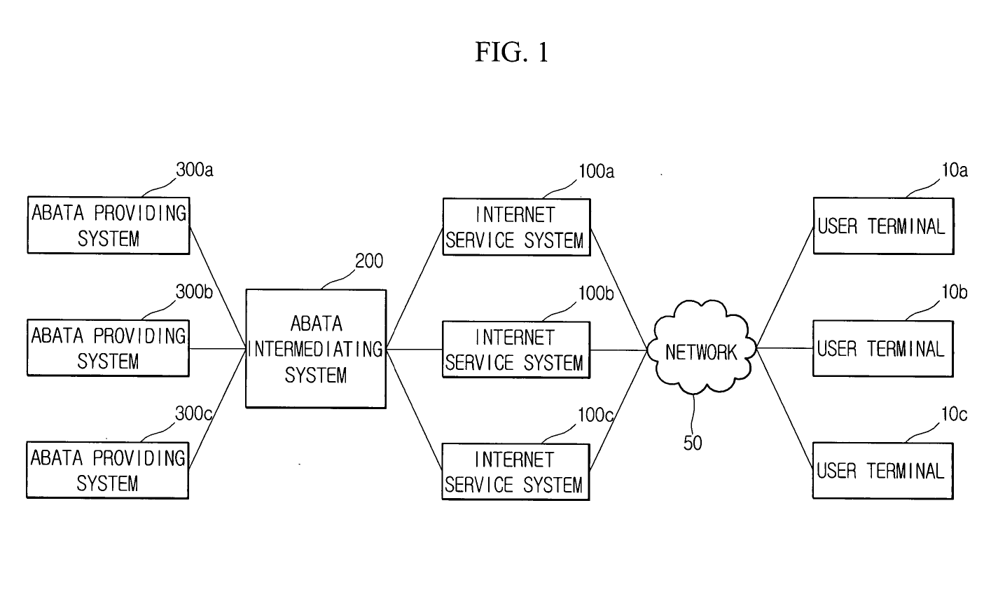

Referring to FIG. 1, the abata intermediating system 200 of the present invention is interposed between a plurality of abata providing systems 300a to 300c and a plurality of Internet service systems 100a to 100c and provides various types of abata images to each Internet service system 100a to 100c. A user accesses the abata intermediating system 200 by using a user terminal 10a to 10c in which a browser program and an instant messenger program are installed. Thus, the user terminals 10a to 10c are connected to the Internet service systems 100a to 100c through a computer network 50, representatively Internet.

The network 50 is used to designate a wired Internet, which is represented by a world wide web (WWW). However, the network is not limited to WWW in the present invention, but may include other types of networks such as wireless Internet based on a wireless communication network.

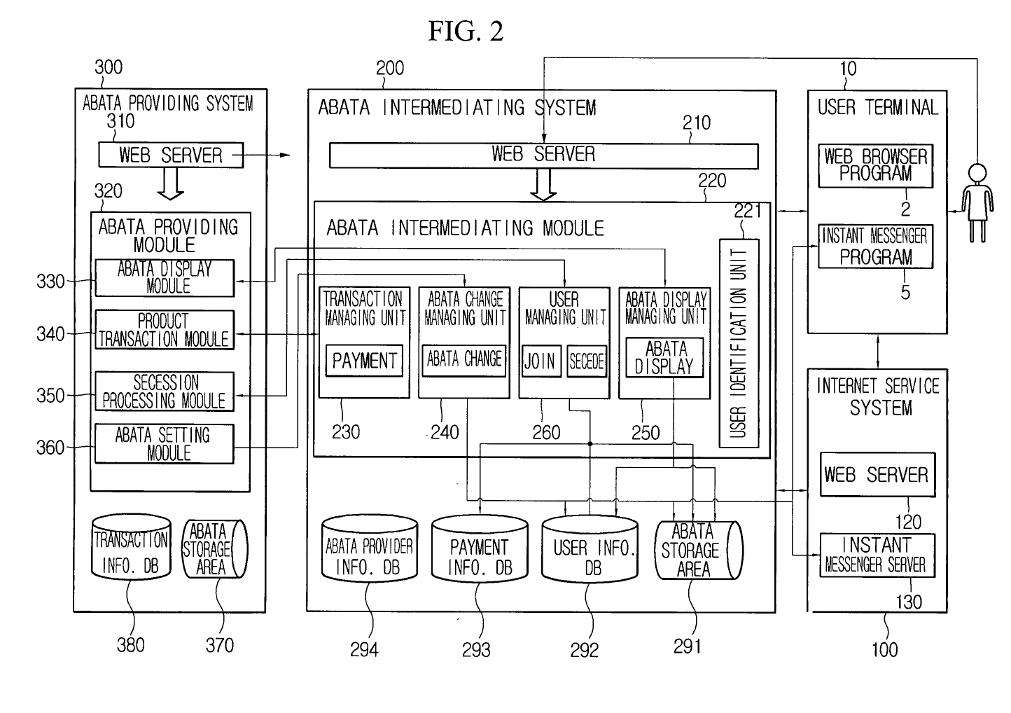

Now, the abata providing system 300 and the abata intermediating system 200 are described in more detail with reference to FIG. 2.

First, the Internet service system 100 of the present invention is a computer system having a web server 120 for providing WWW service to the user terminal 10 and an instant messenger server 130 for providing messenger service. Preferably, the Internet service system 100 acts as a virtual service space on Internet, which provides various kinds of online service by means of abata like a portal search site, a community site and an electronic commerce site.

The user terminal 10 may be a personal computer (PC), a workstation, a cellular phone capable of data communication, PDA or other smaller or larger computer systems. The user terminal 10 typically includes one or more processor, memory and I/O device. A user of the user terminal 10, for example, wishes to access an information record stored by the web server 120. This information record may be shaped as a wired/wireless web page. This web page may be a data record such as not only text information having simple contents but also more complicatedly digitally encoded multimedia contents having software program, graphic, audio signals or picture image. In particular, the user may display his/her own abata on a monitor of the user terminal 10 through the web page.

In addition, the user terminal 10 includes an operating system (OS) for supervising and managing hardware and software of the system for better efficiency, a web browser program 2 such as Navigator or Explorer for positioning the web page, and an instant messenger program 5 which is an application program of a client for transmitting document file, graphic file or voice file through Internet. The instant messenger program 5 is capable of not only simple file transmission but also 1:1 conversation and group discussion.

Thus, a user may display his/her own abata image on the user terminal 10 without access to the Internet service system 100 by using the instant messenger 5, as well as receive an abata image of the opponent from the instant messenger server 130 and display it on the user terminal 10.

The abata intermediating system 200 of the present invention includes a web server 210, an abata intermediating module 220, and a storage device. The abata intermediating module 220 has a transaction managing unit 230, an abata change managing unit 240, a user managing unit 260, an abata display managing unit 250, and a user identification unit 221.

In addition, the storage device includes a database system such as an abata provider information database 294, a payment information database 293 and a user information database 292, and an abata storage area 291.

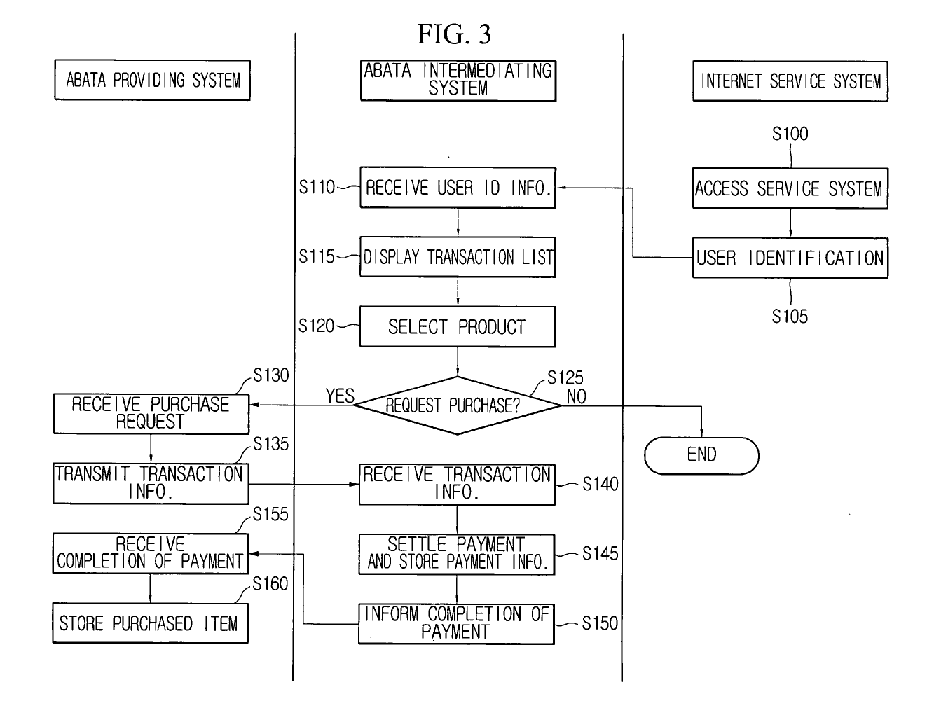

The transaction managing unit 230 of the abata intermediating module 220 is a program module for executing an abata transaction process shown in FIG. 3. That is, the transaction managing unit 230 is linked with a product transaction module 340 of the abata providing system 300 to provide an abata image list, dispatched from a plurality of abata providing systems 300, to the user terminal 10 in a format of web page, transmits a purchase request to the product transaction module 340 of the corresponding abata providing system when a user requests to purchase an abata, receives detailed transaction information from the corresponding abata providing system 300, executes a payment process, and then transmits a payment result to the abata providing system 300.

In addition, the transaction managing unit 230 stores transaction-related and payment-related data generated by the transaction process into the payment information database 293.

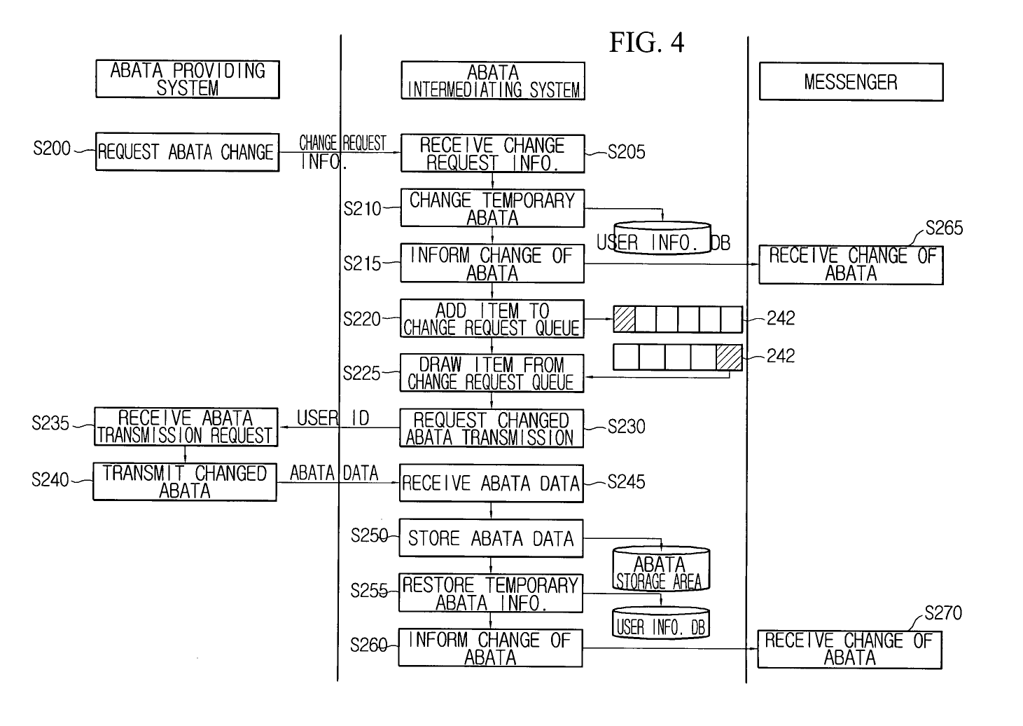

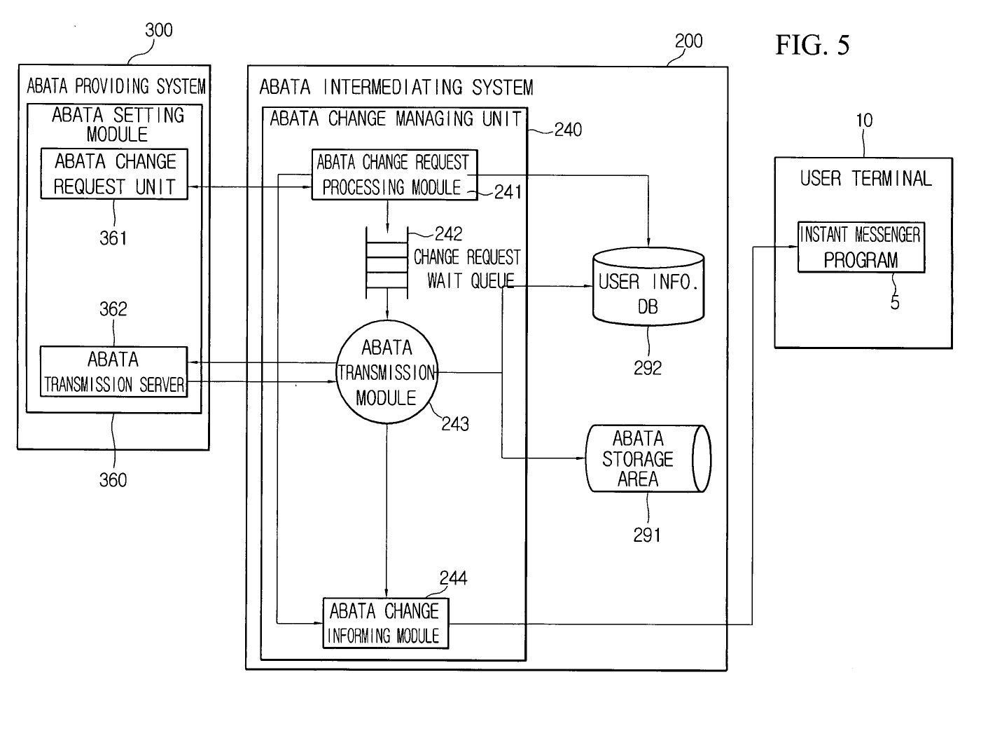

The abata change managing unit 240 of the abata intermediating system 200 is a program module for executing an abata changing process shown in FIGS. 4 and 5 in connection with an abata setting module 360 of the abata providing system 300. When receiving an abata change request from the abata providing system 300, the abata change managing unit 240 updating a representative abata data in the abata storage area 291 by setting a temporary abata or receiving an abata data from the abata providing system 300, and then informs the Internet service system 100 or the instant messenger program 5 of the user terminal 10 that the representative abata is changed.

The user managing unit 260 of the abata intermediating system 200 is a program module for processing that a user joins to or secedes from the intermediating system. In particular, the user managing unit 260 executes a secession process of a user in connection with a secession processing module 350 of the abata providing system 300.

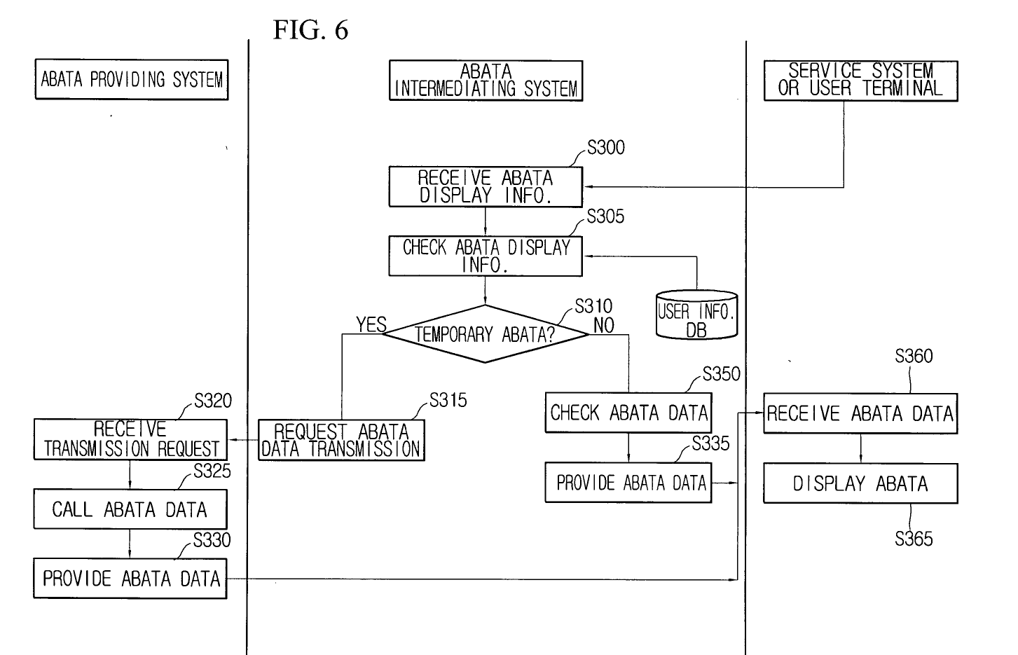

The abata display managing unit 250 of the abata intermediating system 200 is a program process for executing an abata display process shown in FIG. 6 in connection with an abata display module 330 of the abata providing system 300.

The abata display managing unit 250 receives abata display information from the Internet service system 100 or the instant messenger program 5 of the user terminal 10, checks whether the received abata display information is coincident with abata display information stored in the user information database 292, and then provides a temporary abata URL or a changed abata image in the abata storage area 291.

The user identification unit 221 of the abata intermediating system 200 is connected with the Internet service system 100 in order to identify a user on the basis of logging-in information (e.g., ID and password of the user) received from the user.

The abata provider information database 294 is a database for storing and managing environment and data of a plurality of the abata providing systems 300a to 300c.

The payment information database 293 stores and manages transaction-related payment information transmitted from the transaction managing unit 230, and the user information database 292 store and manages personal information of a user (e.g., name, resident registration number, phone number, email address, address or the like), user identification information, abata display information, temporary abata information and so on.

In addition, the abata storage area 291 is a storage area for storing a representative abata image to be displayed on the Internet service system or the user terminal, for each user. The abata information stored in the abata storage area 291 may include picture image, 3D graphic, moving picture, audio information and so on.

The abata providing system 300 of the present invention, which provides various types of abata information through the aforementioned abata intermediating system 200, includes a web server 310, an abata providing module 320, a transaction information database 380 and an abata storage area 370.

The abata providing module 320 again includes an abata display module 330, a product transaction module 340, a secession processing module 350 and an abata setting module 360.

The product transaction module 340 of the abata providing system 300 is a program module for executing a product transaction process shown in FIG. 3 in connection with the transaction managing unit 230 of the abata intermediating system 200. In other words, the product transaction module 340 provides a transaction list related to abata image and abata item to the abata intermediating system 200, extracts and provides transaction information related to a corresponding product according to a purchase request of the transaction managing unit 230, and stores the purchased abata image or abata item for each user.

The abata setting module 360 of the abata providing system 300 is a program module for executing an abata changing process shown in FIGS. 4 and 5 in connection with the abata change managing unit 240 of the abata intermediating system 200. The abata setting module 360 composes a perfect abata image by composing an existing abata image with an abata item selected by the user and then stores the perfect abata image. And then, if the user requests to change the existing representative abata image with the composed abata image, the abata setting module 360 transmits this request to the abata change managing unit 240 of the abata intermediating system 200. In addition, if the changed abata image is transmitted from the abata change managing unit 240, the abata setting module 360 extracts the abata image of the corresponding user from the abata storage area 370, and then transmits the abata image to the abata change managing unit 240.

The abata display module 330 of the abata providing system 300 is a program module for displaying an abata image set in the Internet service system 100 or an abata-using program of the user terminal, in connection with the abata display managing unit 250 of the abata intermediating system 200.

The secession processing module 350 of the abata providing system 300 is a program module for executing a secession process of a user in connection with the user managing unit 260 of the abata intermediating system 200.

The transaction information database 380 of the abata providing system 300 is a database for storing and managing information related to abata image and abata items sold according to the request of user.

The abata storage area 370 of the abata providing system 300 stores abata images composed by users, for each user.

As described above, if desiring to display his/her own abata on the Internet service system or the instant messenger, a user accesses the abata intermediating system, selects an abata providing system which provides a favorite abata image, purchases various abata items from the abata providing system, generates a perfect abata image by suitably composing the purchased items with his/her own abata image, and then displays this image as a representative abata image. In addition, the user may easily change an existing representative abata image with an abata image provided by another abata providing image through the abata intermediating system and then display the changed abata image.

Hereinafter, a method for purchasing, changing and displaying abata according to the present invention is described in detail with reference to FIG. 3.

A user accesses a specific Internet service system 100 (S100), and then completes user identification by inputting logging-in information to the Internet service system 100 (S105). At this time, the user identification unit 221 executes the user identification in connection with the Internet service system 100 with reference to the user information database 292 (S110).

If proved as a proper user, a transaction list including an abata-related product list is displayed on the user terminal. This transaction list screen shows a list of abata providers connected to the abata intermediating system together with detailed product information by drawing the screen from the abata providing system, or receiving and processing relevant information from the abata providing system (S115).

Then, the user checks the abata product list and selects a specific product (e.g., abata image or abata item) (S120). After that, the user requests to purchase the selected product (e.g., by clicking a purchase button) (S125).

The transaction managing unit 230 of the abata intermediating system 200 then transmits the purchase request to the product transaction module 340 of the corresponding abata providing system, and then extracts transaction information corresponding to the purchase request (e.g., product information, transaction ID, price and so on) from the database. The extracted transaction information is transmitted to the transaction managing unit 230 of the abata intermediating system 200 by means of the product transaction module 340 (S130 and S135).

If receiving the transaction information from the product transaction module 340, the transaction managing unit 230 requests a payment to the user (S140). At this time, it is preferred that an instant payment and a debit payment are all possible. If the payment is completed, the corresponding payment information is stored in the payment information database 293 (S145), and the completion of payment is informed to the product transaction module 340 (S150).

If informed of the completion of payment from the transaction managing unit 230 of the abata intermediating system 200, the product transaction module 340 stores the corresponding item for the user (S155 and S160).

By means of the above-mentioned transaction process, a user may purchase various items to be combined with his/her own abata image from each abata providing system and then store the items in his/her own cabinet. In other words, without visiting the abata providing systems one by one as is done on conventional systems, the user may purchase abata-related products from a plurality of abata providing systems just by accessing the abata intermediating system and passing through the user identification.

If purchasing various abata items through the transaction process of the abata intermediating system, a user may change a representative abata image through the process of FIGS. 4 and 5.

In order to change the representative abata image displayed in the Internet service system or the abata-using program, the user perfects an abata image with the use of the items purchased by the process of FIG. 3 from a desired abata providing system. If the abata image to be replaced with an existing representative abata image is perfected, the user requests a change of abata to the abata setting module 360 of the corresponding abata providing system. In other words, an abata change requesting unit 361 of the abata setting module 360 generates change request information including user ID and abata provider ID, and then transmits the change request information to the abata change managing unit 240 of the abata intermediating system 200 (S200).

Upon receiving the change request information from the abata providing system 300, an abata change request processing module 241 of the abata change managing unit 240 changes temporary abata information in the user information database 292 (S205 and S210), and then an abata change informing module 244 informs the Internet service system and the instant messenger program 5 of the user terminal that the abata is changed (S215).

The Internet service system or the messenger, informed from the abata change request processing module 241 of the abata intermediating system 200 that the abata is changed, then temporarily stores the fact (S265).

After completing the setting of the temporary abata for changing the representative abata image, the abata change request processing module 241 adds a change request item in a change request wait queue 242 (S220).

As mentioned above, the abata intermediating system does not process the abata change request instantly but sets the temporary abata so that the changed abata image may be provided when a request for display of the abata is received from the Internet service system or the messenger before the process for the abata change request is finished.

An abata transmission module 243 of the abata change managing unit 240 reads a change request item from a head of the change request wait queue 242 (S225), and then requests transmission of the changed abata image to an abata transmission server 362 on the basis of the change request information designated by the change request item (S230).

The abata transmission server 362 then extracts the perfected changed abata image from the abata storage area 370 in response to the changed abata transmission request including user ID from the abata transmission module 243 of the abata intermediating system 200, and then transmits the extracted changed abata data to the abata transmission module 243 of the abata intermediating system 200 (S235 and S240).

Upon receiving the changed abata data (S245), abata transmission module 243 updates an existing abata image stored in the abata storage area 291 to the changed abata data (S250).

After updating the abata data, the abata transmission module 243 restores the temporary abata information of the user information database 292 as it was (S255), and the abata change informing module 244 informs the Internet service system 100 and the instant messenger program 5 of the user terminal 10 that the abata is changed (S260).

Upon being informed from the abata change informing module 244 of the abata intermediating system 200 that the abata is changed, the Internet service system and/or the messenger temporarily memorizes this fact (S270).

If the user newly accesses the Internet service system or newly executes the instant messenger in the state of already requesting the change of his/her own representative abata image, the changed abata image is displayed through the Internet service system or the instant messenger as shown in FIG. 6.

Referring to FIG. 6, if a user accesses the Internet service system or executes the messenger of the user terminal, the Internet service system or the messenger transmits abata display information to the abata display managing unit 250 of the abata intermediating system 200 on the basis of the change history of the temporarily stored abata. Upon receiving the abata display information from the Internet service system or the messenger, the abata display managing unit 250 compares the received display information with display information stored in the user information database 292 in order to determine whether they are coincident (S300 and S305).

If it is determined that the display information is coincident, the abata display managing unit 250 determines whether the abata to be displayed is a temporary abata (S310). At this time, if the abata is determined to be a temporary abata, the abata display managing unit 250 requests transmission of the corresponding abata image to the abata providing system on the basis of a temporary abata URL in the user information database (S315).

Upon receiving the request for transmission of the abata image from the abata intermediating system 200, the abata display module 330 of the abata providing system 300 calls a resource corresponding to the temporary abata URL from the abata storage area 370, and transmits the called abata data to the user terminal (S320, S325 and S330).

On the other hand, if it is determined that the abata to be displayed is a formal abata in the step S310, the abata display managing unit 250 reads the abata data from the abata storage area 291, and then transmits the abata data to the user terminal (S350 and S355).

As described above, upon receiving the changed abata data from the abata providing system or the abata intermediating system, the Internet service system or the messenger of the user terminal updates an existing representative abata image into the received abata image and then displays the received abata image (S360 and S365).

### APPLICABILITY TO THE INDUSTRY

The abata intermediating system and method according to the present invention allow a user to set various types of images, provided from a plurality of abata providing systems, as his/her own abata without changing the Internet service system. In particular, the present invention enables a user to easily change and display an existing abata image in an entirely different type of abata image.

What is claimed is:

1. An abata intermediating system comprising:
at least one abata providing device, each abata providing device in the at least one abata providing device for storing abata data that includes at least one of (i) one or more abata images and (ii) one or more abata item images, and for providing the stored abata data through a network;
an abata service device for receiving the abata data from an abata providing device in the at least one abata providing device and for supplying the abata data in the form of an electronic document;
a user terminal for outputting the abata data through the abata service device or a client program; and
an abata intermediating device that includes instructions for:
accepting abata data provided from a selected abata providing device in the at least one abata providing device;
intermediating a transaction of the abata data between the selected abata providing device and the user terminal;
receiving a changed abata image from the selected abata providing device in response to an abata change request; and
changing a representative abata image of the abata service device or the client program into the changed abata image.

2. An abata intermediating system according to claim 1, wherein an abata providing device in the at least one abata providing device includes:
a storage means for storing purchased abata data for each user in a plurality of users;
an abata composing means for generating a perfected abata image by combining an abata image stored in the storage means with a selected abata item image;
means for providing the perfected abata image to the abata intermediating device in response to a change request of a user; and
means for providing transaction information of the corresponding abata data to the abata intermediating device in response to a purchase request of a specific abata data from the user.

3. An abata intermediating system according to claim 2, wherein the abata intermediating device includes:
an abata purchasing means for
(i) providing an abata data list from an abata providing device in the at least one abata providing device to the plurality of users,
(ii) transmitting a purchase request of a specific abata data from the user to the abata providing device when the user purchases the abata data,
(iii) outputting abata purchasing information received from the abata providing device to the user,
(iv) receiving payment information from the user, and
(v) transmitting payment settlement to the abata providing device, and
an abata storage means for storing a composed abata image transmitted from the abata providing device for each user.

4. An abata intermediating system according to claim 3, further comprising an abata changing means for
receiving and storing an abata image change request and a changed abata data from the abata providing device, and
informing the abata service device or the client program of the user terminal that the abata image is changed.

5. An abata intermediating system according to claim 4, wherein the abata changing means includes:
means for receiving change request information from the abata providing device;
means for inputting a change request item into a wait queue;
means for storing temporary abata information into a database;
means for reading the stored change request item from the wait queue and requesting transmission of the abata data to the abata providing device;
means for receiving and storing the abata data transmitted from the abata providing device and restoring the temporary abata information stored in the database; and
means for informing the abata service device or the client program of the user terminal that the abata image is changed.

6. An abata intermediating system according to claim 5,
wherein the change request item includes user identification information and abata provider identification information.

7. An abata intermediating system according to claim 5,
wherein the temporary abata information includes user identification information and a temporary abata URL.

8. An abata intermediating system according to claim 5,
wherein the abata intermediating device further includes an abata display means for providing the abata image stored in the abata storage means to the client program or the abata service device in response to an abata display request from the client program of the user terminal or the abata service device.

9. An abata intermediating system according to claim 8, wherein the abata display means:
receives abata display information from the client program of the user terminal or the abata service device;
determines, as a function of the abata display information, whether the abata to be provided is a formal abata or a temporary abata;
requests provision of the abata image to the abata providing device when the abata to be provided is a temporary abata; and
provides an abata image stored in the abata storage means when the abata to be provided is a formal abata.

10. An abata intermediating method for executing an abata intermediating system that interfaces between a plurality of abata providing systems and an abata-using Internet service system or an abata-using program of a user terminal via a network in order to reflect an abata image, set by selection of a user among various types of abata images provided from a plurality of abata providing systems, on the abata-using Internet service system or the abata-using program of the user terminal, the method comprising:
building a user information database for storing and managing user identification information and abata display information corresponding to the user identification information,
building an abata provider information database for storing and managing environment and data of a plurality of abata providing systems;
setting a representative abata image to be displayed in the abata-using Internet service system or the abata-using program of the user terminal;
storing the representative abata image into an abata storage means;
accessing the abata intermediating system via the network and inputting user identification information;
outputting a list of abata providing systems connected to the abata intermediating system and an abata data list of each abata providing system to the user;
purchasing a specific abata image or abata item in the abata data list, and storing the purchased abata data into the corresponding abata providing system together with the user identification information;
composing an abata image with the use of the abata image and abata item stored in a specific abata providing system;
requesting the corresponding abata providing system to change the representative abata image into the composed abata image;
transmitting the abata image change request to the abata intermediating system;
informing the abata-using Internet service system or the abata-using program of the user terminal on the basis of the abata image change request that the abata image is changed;
receiving the abata image from the corresponding abata providing system according to the abata image change request; and
updating the representative abata image of the abata storage means on the basis of the received abata image.

11. An abata intermediating method according to claim 10, wherein the abata image updating includes instructions for:
receiving the abata image change request;
inputting a change request item into a wait queue;
storing temporary abata information into a database;
reading the stored change request item from the wait queue;
requesting transmission of the abata data to the corresponding abata providing device;
receiving the abata image transmitted from the corresponding abata providing system to update the representative abata image of the abata storage means; and
restoring the temporary abata information of the user information database.

12. An abata intermediating method according to claim 11, further comprising:
in the abata-using program informed of the abata change from the abata intermediating system:
transmitting the abata display information to the abata intermediating system in order to display the changed abata image; and
in the abata intermediating system:
determining whether the transmitted abata display information is coincident with the abata display information stored in the user information database;
determining whether an abata included in the corresponding abata display information is a temporary abata or a formal abata when the abata display information is coincident;
updating and displaying the representative abata image on the basis of the URL of the temporary abata stored in the user information database when the abata is a temporary abata; and
transmitting the abata image stored in the abata storage means to the user terminal, and updating and displaying the representative abata image when the abata is a formal abata.

13. The abata intermediating system of claim 1, wherein the client program is a messenger.

14. The abata intermediating system of claim 1, wherein the electronic document is a web document.

15. The abata intermediating method of claim 11, wherein the change request item comprises the user identification information and the abata provider identification information.

16. The abata intermediating method of claim 12, wherein the abata display information comprises user identification information, kind of abata, and abata countenance.

17. The abata intermediating method of claim 9, wherein the abata display information comprises user identification information, kind of abata, and abata countenance.

18. The abata intermediating method of claim 11, wherein the temporary abata information comprises the user identification information and the URL of the temporary abata.
